(19) United States
(12) Patent Application Publication
(10) Pub. No.: US 2012/0241425 A1
(43) Pub. Date: Sep. 27, 2012

(54) LASER MACHINING APPARATUS, METHOD FOR LASER MACHINING, AND MEDIUM FOR LASER MACHINING PROGRAM

(75) Inventors: Tooru HARADA, Kawasaki (JP); Katsuki Shirai, Yokohama (JP)

(73) Assignee: FUJITSU LIMITED, Kawasaki-shi (JP)

(21) Appl. No.: 13/413,830

(22) Filed: Mar. 7, 2012

(30) Foreign Application Priority Data
Mar. 22, 2011 (JP) 2011-062085

(51) Int. Cl. B23K 26/38

(52) U.S. Cl. 219/121.72; 219/121.67

(57) ABSTRACT

A method which processes a work-piece by a laser machining apparatus, the method includes: forming a groove by laser light irradiated from the laser machining apparatus along a target line of the work-piece which is the boundary between a first area remaining after laser machining and a second area to be removed in the laser machining under a first machining condition in which the work-piece is not penetrated by the laser machining; and irradiating the work-piece with the laser light at a position that is in the second area and at least partially overlaps the groove under a second machining condition in which the work-piece is penetrated.

### CROSS-REFERENCE TO RELATED APPLICATION

This application is based upon and claims the benefit of priority of the prior Japanese Patent Application No. 2011-62085, filed on Mar. 22, 2011, the entire contents of which are incorporated herein by reference.

### FIELD

The embodiment discussed herein is related to a laser machining apparatus, a method of machining for laser machining, and a medium for laser machining program.

### BACKGROUND

A laser machining apparatus machines a work-piece with the irradiation of laser light. The laser machining apparatus machines the work-piece by moving an irradiation position of laser light along a target line. If the position of work-piece is fixed, the irradiation position of laser light is moved by using a galvanometer mirror which deflects laser light. It will therefore be possible to machine the work-piece at a fixed position by using a laser machining apparatus provided with a galvanometer mirror.

There has been a problem that absorption of laser light varies depending on surface roughness of the work-piece and, as a result, machining quality varies. In order to address this problem, a laser machining method has been proposed in which preliminary machining is carried out with laser light under a preliminary machining condition to modify a surface of a work-piece and, thereafter, main machining is carried out.

A laser machining method has been proposed which carries out preliminary machining and main machining with different focus positions of laser light along the depth direction of the work-piece in order to reduce disturbance in cutting of the work-piece by adhesive materials adhering to the work-piece.

In related art laser machining method, the same position of the work-piece is irradiated with laser light in preliminary machining and in main machining; thus, heat is easily transmitted to the area around the position irradiated with laser light. Therefore, in a case in which a work-piece made of a heat-shrinkable material, such as resin and plastic, is irradiated with laser light, heat deformation may occur near a position irradiated with laser light, thereby decreasing machining precision. If laser power is lowered, machining precision by heat deformation may be reduced.

However, there is another problem that debris may adhere to the work-piece so as to leave the work-piece unusable in subsequent processes, or that additional operation may desirably be used to remove the debris off the work-piece. Multi-time irradiation of laser with different focusing may restrict the decrease of machining precision and reduce debris. However, the laser irradiation apparatus with different focusing may desirably be prepared. Alternatively, a mechanism for adjusting focusing at each irradiation event is desirably introduced. Multi-time laser irradiation with different focusing may cause a decrease in reproducibility of machining precision and an increase in cost of the laser machining apparatus.

Japanese Laid-open Patent Publication Nos. 07-236984 and 2008-194719 are examples of the related art.

### SUMMARY

According to an aspect of the invention, a method which processes a work-piece by a laser machining apparatus, the method includes: forming a groove by laser light irradiated from the laser machining apparatus along a target line of the work-piece which is a boundary between a first area remaining after laser machining and a second area to be removed in the laser machining under a first machining condition in which the work-piece is not penetrated by the laser machining; and irradiating the work-piece with the laser light at a position that is in the second area and at least partially overlaps the groove under a second machining condition in which the work-piece is penetrated.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram illustrating an exemplary laser machining apparatus;

FIG. 2 is a plane view illustrating an exemplary work-piece;

FIG. 3A is a plane view illustrating a machining pattern formed by a first machining process;

FIG. 3B is a A-A cross sectional view of the work-piece of FIG. 3A after the first machining process.

FIG. 4A is a plane view illustrating a machining pattern formed by a second machining process;

FIG. 4B is a A-A cross sectional view of the work-piece of FIG. 4A after the second machining process.

FIG. 5A is a A-A cross sectional view of the work-piece of FIG. 4B, which is formed in theory;

FIG. 5B is a A-A cross sectional view of the work-piece of FIG. 4B, which is actually formed;

FIG. 6 is a method which illustrates an exemplary laser machining program;

FIG. 7A is a plane view illustrating an exemplary first machining pattern; and

FIG. 7B is a plane view illustrating an exemplary second machining pattern.

### DESCRIPTION OF EMBODIMENT

### Laser Machining Apparatus

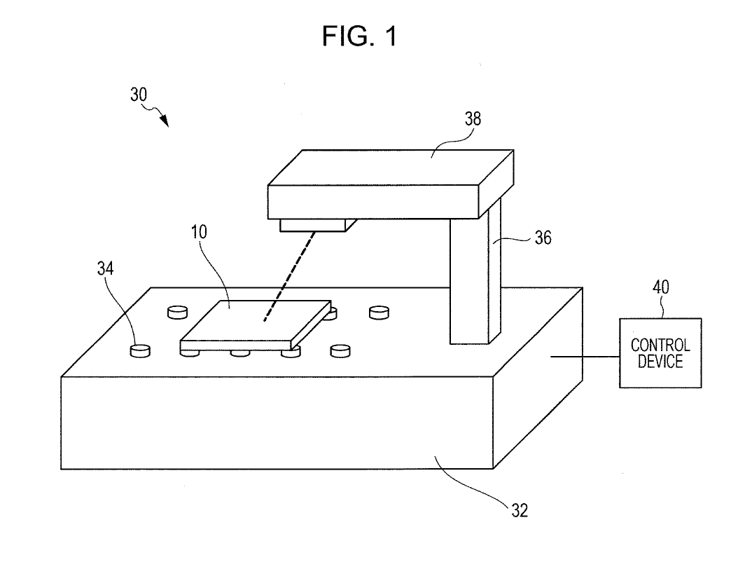

First, with reference to FIG. 1, a laser machining apparatus of the present embodiment will be described. FIG. 1 is a schematic configuration diagram illustrating an exemplary laser machining apparatus 30 of the present embodiment. The Laser machining apparatus 30 carries out laser machining of a work-piece 10 which is made of a heat-shrinkable material, such as resin and plastic. The laser machining apparatus 30 is provided with a base unit 32, a support 34, a fixing unit 36, a laser head 38 and a control device 40.

The base unit 32 has a planar upper surface. The support 34 is disposed on the upper surface of the base unit 32. In the example illustrated in FIG. 1, a plurality of cylindrical supports 34 is disposed on the upper surface of the base unit 32. The support 34 supports the work-piece 10. Since the support 34 supports the work-piece 10, diffusion of heat, produced by the irradiation of laser on the work-piece 10, on the upper surface of the base unit 32 may be controlled. It is therefore possible to reduce problems, such as adhesion of debris to the work-piece 10 caused by insufficient laser machining. The shape and the number of the support 34 are not especially limited as long as the work-piece 10 is supported.

The fixing unit 36 is fixed to the base unit 32. The fixing unit 36 fixes the laser head 38 such that the laser head 38 faces the base unit 32. The laser head 38 is provided with a galvanometer mirror which deflects laser light; the work-piece 10 may be scanned and irradiated with the deflected laser light.

The control device 40 is, for example, a computer, such as a personal computer. The control device 40 is connected to the laser head 38 and controls laser light irradiated by the laser head 38. The control device 40 is provided with a reading unit (not illustrated) which reads data of a target line. The control device 40 controls a machining condition, such as laser power and the scanning speed, and the position at which laser light is irradiated by the laser head 38 in accordance with the target line data read by the reading unit of the control device 40. Higher power contributes to greater machinability of the work-piece 10. Lower scanning speed of laser light contributes to greater machinability of the work-piece 10.

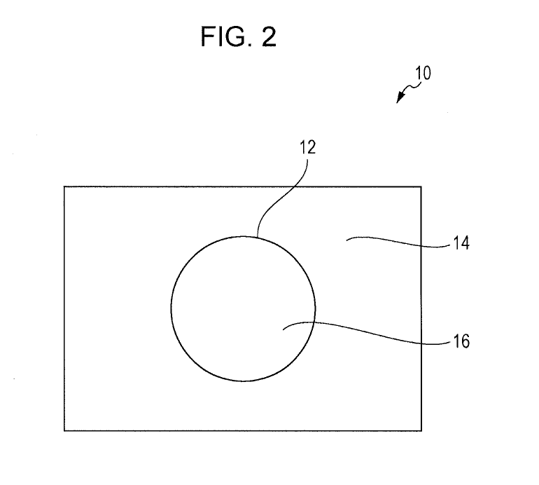

Next, the work-piece 10 to be machined by the laser machining apparatus 30 will be described with reference to FIG. 2. FIG. 2 is a plane view illustrating an example of the work-piece 10. The work-piece 10 is formed of a heat-shrinkable material, such as resin and plastic. FIG. 2 illustrates an example in which a circular pattern is cut off from the work-piece 10.

The work-piece 10 includes a first area 14 and a second area 16. The first area 14 remains after the work-piece 10 is machined with laser. In the example illustrated in FIG. 2, the first area 14 is outside the circle. The second area 16 is removed in the laser machining. In the example illustrated in FIG. 2, the second area 16 is inside the circle. A target line 12 is a boundary of the first area 14 and the second area 16. Note that the target line 12 illustrates a virtual target position at which the work-piece 10 is machined by the irradiation of laser light from the laser machining apparatus 30 and thus is not actually drawn on the work-piece 10.

Laser Machining Method

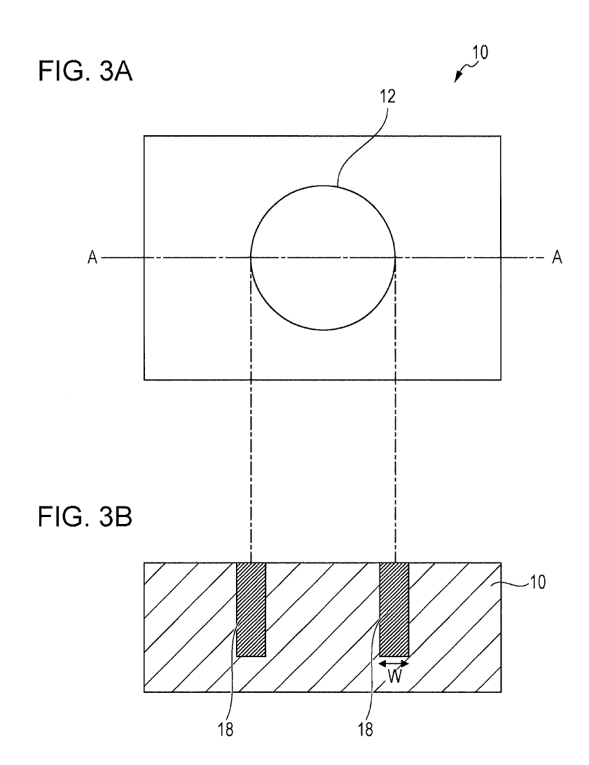

Next, a laser machining method of the present embodiment will be described. The laser machining method of the present embodiment includes a first machining process and a second machining process. Hereinafter, the first machining process will be described with reference to FIGS. 3A and 3B.

FIG. 3A is a plane view illustrating a machining pattern in the first machining process. FIG. 3B is an A-A cross sectional view of FIG. 3A after the first machining process. In the first machining process, the control device 40 controls the laser head 38 such that laser light is irradiated along the target line 12 as illustrated in FIG. 3A. In the first machining process, the control device 40 controls the laser head 38 to irradiate laser light under the machining condition in which laser light does not fully penetrate the work-piece 10 (i.e., the first machining condition) as illustrated in FIG. 3B. A first to-be-removed-area 18 is removed from the work-piece 10 in the first machining process.

In the example illustrated in FIGS. 3A and 3B, the width W of laser light with which the work-piece 10 is irradiated is, for example, 400 micrometers. Supposing that the laser power is P₁ and the scanning speed of laser light is V₁ under the first machining condition, the laser power P₁ and the scanning speed V₁ may be arbitrarily determined in a range in which laser light does not fully penetrate the work-piece 10 and in which the second area 16 does not fall from the work-piece 10 by its own weight after the first machining process.

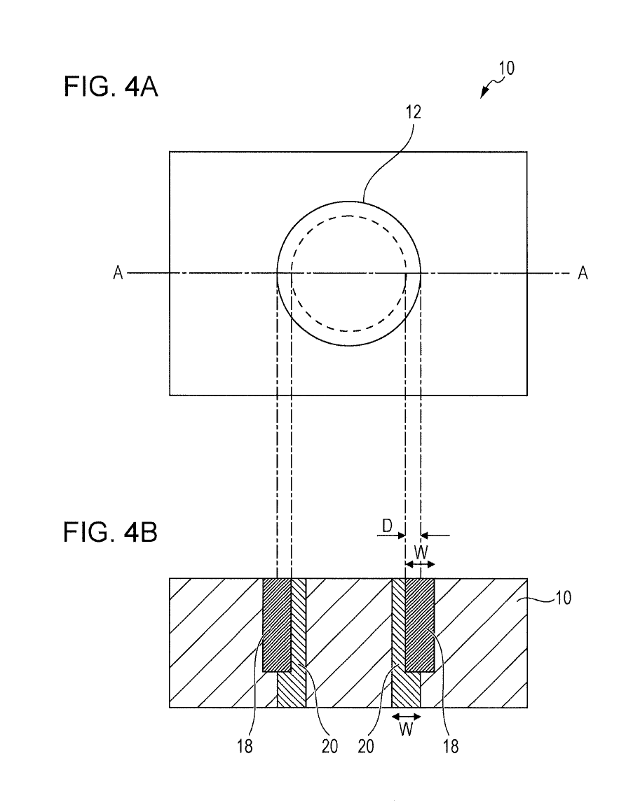

Next, the second machining process will be described with reference to FIGS. 4A and 4B. FIG. 4A is a plane view illustrating a machining pattern of the second machining process. FIG. 4B is a A-A cross sectional view of FIG. 4A after the second machining process. In the second machining process, the control device 40 controls the laser head 38 to irradiate laser light further toward the second area 16 (i.e., the circle illustrated in FIG. 4A by a dashed line) than the target line 12 as illustrated in FIG. 4A. In the second machining process, the control device 40 controls the laser head 38 to irradiate laser light under the machining condition in which laser light penetrates the work-piece 10 (i.e., the second machining condition) as illustrated in FIG. 4B. A second to-be-removed-area 20 is removed from the work-piece 10 in the second machining process. When the second to-be-removed-area 20 is removed, the second area 16 inside the circular target line 12 is cut off.

FIG. 4B illustrates that a position shifted toward the second area 16 from the target line 12 by distance D is irradiated with laser light. The second to-be-removed-area 20 partially overlaps the first to-be-removed-area 18 when seen in a plane view. The distance D is preferably equal to or smaller than the width W of laser light and more preferably is equal to or smaller than a half the width W of laser light. For example, supposing that the width of laser light is 400 micrometers, the distance D is preferably equal to or smaller than 200 micrometers. This is because if the distance D is equal to or smaller than a half the width W of laser light, a protruding area below the target line 12 described below is reduced in size and therefore a machined end becomes smoother. Supposing that the laser power is P₂ and the scanning speed of laser light is V₂ under the second machining condition, the laser power P₂ and the scanning speed V₂ may be determined suitably as long as laser light penetrates the work-piece 10.

Here, a relationship between the first machining condition and the second machining condition in the present embodiment will be described. In the present embodiment, the scanning speed V₁ of laser light under the first machining condition and the scanning speed V₂ of laser light under the second machining condition are not particularly limited; V₁ and V₂ may be the same. Although the laser power P₁ under the first machining condition is preferably lower than the laser power P₂ under the second machining condition in the present embodiment, the ratio between P₁ and P₂ may be determined arbitrarily. For example, P₁ is a half of P₂. The width W of laser light with which the work-piece 10 is irradiated is the same under the first machining condition and under the second machining condition. In the present embodiment, laser light is irradiated from the same laser head 38 under the first machining condition and under the second machining condition with changed laser power. This means that the width W of laser light, i.e., focusing, is not changed.

In the present embodiment, since laser light is irradiated along the target line 12 at the power P₁ which is lower than the laser power P₂ under the second machining condition in the first machining process, occurrence of heat deformation near the target line 12 may be reduced. Since the first to-be-removed-area 18 has been removed in the first machining process, thermal resistance of the work-piece 10 increases when a portion further toward the second area 16 than the target line 12 is irradiated with laser light in the second machining process. Therefore, even if laser light is irradiated at the power P₂ which is higher than the laser power P₁ of the first machining process, heat generated by laser light is not easily transmitted to a portion further toward the first area 14 than the target line 12. As a result, occurrence of heat deformation may be reduced near the target line 12 also in the second machining process.

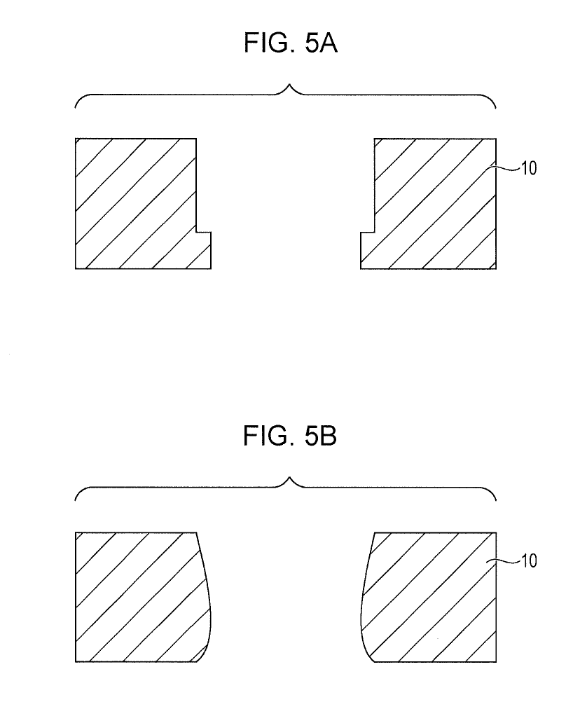

Next, a cross sectional shape of the work-piece 10 after the second machining process will be described with reference to FIGS. 5A and 5B. FIG. 5A is a A-A cross sectional view of the work-piece of FIG. 4B, which is formed in theory. That is, FIG. 5A illustrates the work-piece 10 illustrated in FIG. 4B from which the first to-be-removed-area 18, the second to-be-removed-area 20 and inside the second to-be-removed-area 20 are removed. FIG. 5B illustrates an example of the actual A-A cross sectional view after the work-piece 10 is machined in the present embodiment.

As illustrated in FIG. 5A, the A-A cross sectional view assumed from FIG. 4B is considered to a protruding area below the target line 12 (i.e., the side opposite to the side irradiated with laser light). Actually, however, the cross section near the target line 12 is smooth as illustrated in FIG. 5B. This is because heat generated by the irradiation of laser light in the second machining process is transmitted to a protruding portion remained below the target line 12 after the first machining process, and the protruding area melts; and the surface tension produces a smooth shape as illustrated in FIG. 5B. In order that the protruding portion remained below the target line 12 after the first machining process melts easily, the first machining condition is preferably determined such that the depth of the first to-be-removed-area 18 is equal to or greater than a half the thickness of the work-piece 10.

The machining conditions of the present embodiment are as follows. The work-piece 10 is made of polypropylene. The laser light is CO₂ laser with the wavelength of 10.6 micrometers and the maximum output of 30 W. In the first machining condition, the laser output is 30% and the scanning speed is 60 mm per second. In the second machining condition, the laser output is 80% and the scanning speed is 60 mm per second. The machining pattern of the second machining process is shifted by 200 micrometers with respect to the machining pattern of the first machining process.

According to the present embodiment, as described above, since the first machining process in which laser light is irradiated along the target line 12 is carried out under the first machining condition and, thereafter, the second machining process in which a portion further toward the second area 16 than the target line 12 is irradiated with laser light is carried out under the second machining condition, occurrence of heat deformation near the target line 12 may be reduced and, as a result, machining precision of the work-piece 10 may be increased.

In the present embodiment, the laser power P₁ under the first machining condition may be determined to be P₁<P₂ in a range in which laser light does not fully penetrate the work-piece 10 and in which the second area 16 does not fall from the work-piece 10 by its own weight after the first machining process.

In the present embodiment, the scanning speed V₁ of laser light under the first machining condition and the scanning speed V₂ of laser light under the second machining condition may be different from each other. For example, the scanning speed V₁ may be higher than the scanning speed V₂ in a state in which the laser power P₁ under the first machining condition and the laser power P₂ under the second machining condition are the same. This is because the work-piece 10 is not easily machined at an increased scanning speed under the conditions with the same laser power. Also in the present embodiment, machining may be carried out without changing the width of laser light, i.e., focusing.

Laser Machining Program

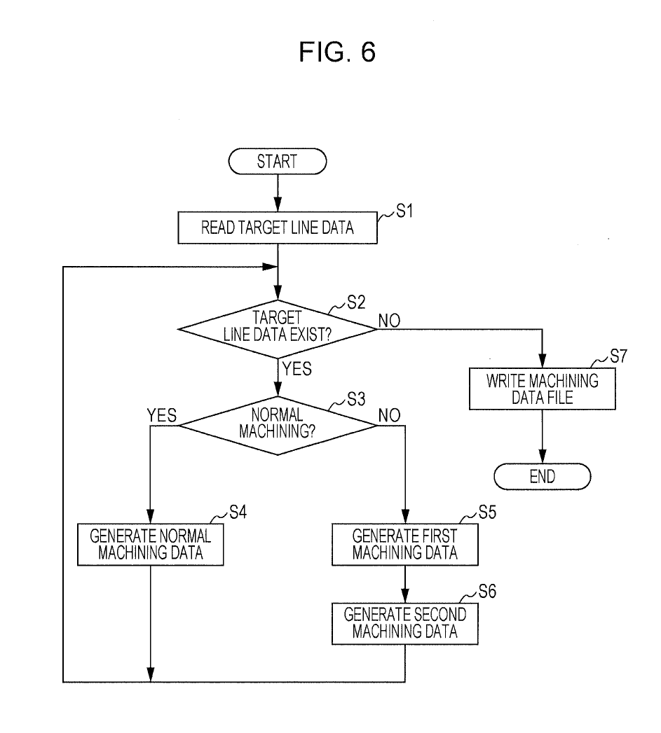

Next, a laser machining program of the present embodiment will be described with reference to FIG. 6. FIG. 6 is a method which illustrates an exemplary laser machining program of the present embodiment. The laser machining program of the present embodiment makes the control device 40 carry out a procedure to generate first machining data used in the first machining process and second machining data used in the second machining process in accordance with the read target line data. Hereinafter, each operation will be described.

An example in which a circular pattern is cut off the work-piece 10 will be described. First, control device 40 is made to carry out procedure of reading data of target line (operation S1). The target line data is, for example, CAD data. The target line data as illustrated in FIG. 2 is prepared in advance.

If heat deformation near the target line, such as the periphery of the work-piece 10 is acceptable or if characters are to be drawn by the laser machining, machining may be carried out under a normal machining condition under which laser light penetrates the work-piece 10. Therefore, the target line 12 to be machined under the normal machining condition and the target line 12 to be machined in the first machining process and the second machining process as described above may be distinguished from each other. For example, the target line data may be prepared in the following manner: data of the target line to be machined under the normal machining condition is represented by a solid line and data of the target line to be machined in the first machining process and the second machining process is represented by a dashed line.

Next, the control device 40 is made to carry out a procedure for determining whether there is any data of the target line 12 which has not been machined among the data of the target line 12 read in the operation S1 (operation S2). If there is data of the target line 12 which has not been machined, the control device 40 is made to carry out a procedure for determining whether the target line 12 is to be machined under the normal machining condition (operation S3).

If the target line 12 is to be machined under the normal machining condition, the control device 40 is made to carry out a procedure for generating normal machining data (operation S4). Here, the normal machining data includes a machining condition under which laser light penetrates the work-piece 10 (i.e., a normal machining condition) and a machining pattern with which machining is carried out along the target line 12 (i.e., a normal machining pattern).

If, on the other hand, the target line 12 is not to be machined under the normal machining condition, the control device 40 is made to carry out a procedure for generating the first machining data (operation S5). The control device 40 is then made to carry out a procedure for generating the second machining data (operation S6). Here, the first machining data includes a machining condition under which laser light does not fully penetrate the work-piece 10 (i.e., the first machining condition) and a machining pattern with which machining is carried out along the target line 12 (i.e., a first machining pattern). The second machining data includes a machining condition under which laser light penetrates the work-piece 10 (i.e., the second machining condition) and a machining pattern with which machining is carried out on the side further toward the second area 16 than the target line 12 (i.e., a second machining pattern).

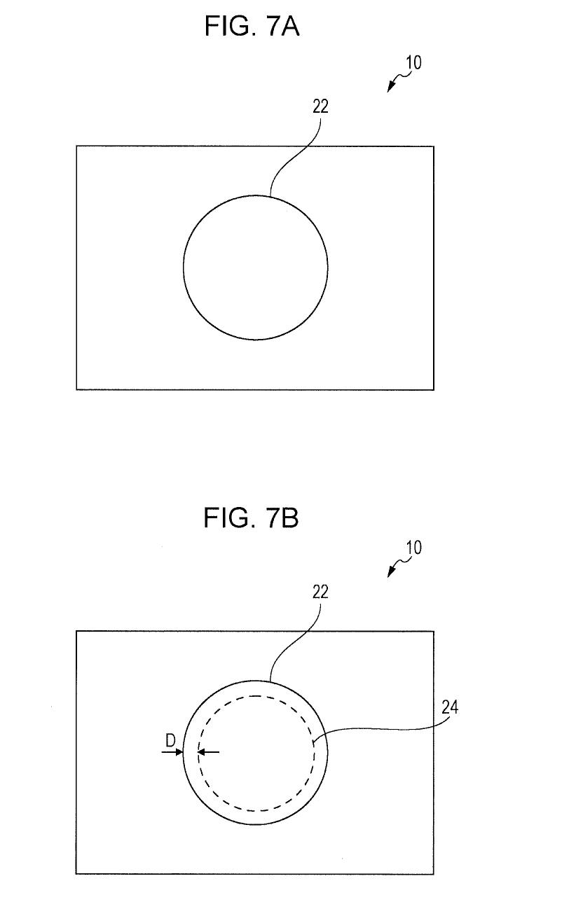

Here, the first machining pattern included in the first machining data generated in the operation S5 and the second machining pattern included in the second machining data generated in the operation S6 will be described with reference to FIGS. 7A and 7B. FIG. 7A illustrates an exemplary first machining pattern 22. FIG. 7B illustrates an exemplary second machining pattern 24.

The first machining pattern 22 included in the first machining data generated in the operation S5 is the same pattern as the target line 12 as illustrated in FIG. 7A. Data of the laser power P₁ and the scanning speed V₁ with which laser light does not fully penetrate the work-piece 10 is included in the first machining condition included in the first machining data. The second machining pattern 24 included in the second machining data generated in the operation S6 is a circular machining pattern situated further toward the second area 16 than the target line 12 as illustrated in FIG. 7B. Data of the laser power P₂ and the scanning speed V₂ with which laser light penetrates the work-piece 10 is included in the second machining condition included in the second machining data.

After the operation S4 in which the normal machining data is generated, or the operation S6 in which the second machining data is generated is completed, the procedure returns to the operation S2 where the control device 40 is made to carry out a procedure for determining whether there is any data of the target line 12 which has not been machined. The operations S2 to S6 are repeated until it is determined in the operation S2 that there is no data of the target line 12 which has not been machined. If it is determined in the operation S2 that there is no data of the target line 12 which has not been machined, the control device 40 is made to carry out a procedure for writing a machining data file including the normal machining data, the first machining data and the second machining data for all the target lines (operation S7).

According to the laser machining program of the present embodiment, machining data for carrying out the laser machining method described above may be generated by reading the data of the target line which includes information about whether the normal machining is to be carried out or the machining in the first machining process and the second machining process is to be carried out. By carrying out laser machining using the machining data generated by the laser machining program of the present embodiment, occurrence of heat deformation near the target line 12 may be reduced and, as a result, machining precision of the work-piece 10 may be increased.

Although the present embodiment has been described with reference to an example in which the control device 40 executes the laser machining program, the present embodiment is not limited thereto. For example, a computer provided outside the laser machining apparatus 30 may execute the laser machining program of the present embodiment and the control device 40 of the laser machining apparatus 30 may read the generated machining data file.

Although the laser machining apparatus, the laser machining method and the laser machining program of the embodiment have been described in detail, the embodiment is not limited thereto. Various improvements and modifications may be made without departing from the scope of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method which processes a work-piece by a laser machining apparatus, the method comprising:
forming a groove by laser light irradiated from the laser machining apparatus along a target line of the work-piece which is a boundary between a first area remaining after laser machining and a second area to be removed under a first machining condition in which the work-piece is not completely penetrated by the laser machining; and
irradiating the work-piece with the laser light at a position that is in the second area and at least partially overlaps the groove under a second machining condition in which the work-piece is penetrated.

2. The method according to claim 1, wherein a power of the laser light under the first machining condition is lower than a power of the laser light under the second machining condition.

3. The method according to claim 1, wherein a scanning speed of the laser light under the first machining condition is higher than a scanning speed of the laser light under the second machining condition.

4. A laser machining apparatus configured to process a work-piece by using a laser machining apparatus, the laser machining apparatus comprising:
a base unit on which the work-piece is placed;
a laser head that is disposed to face the base unit and irradiates laser light; and
a controller that controls the laser head to irradiate the work-piece with the laser light on a target line which is a boundary between a first area remaining after laser machining and a second area to be removed under a first machining condition in which the work-piece is not completely penetrated and, thereafter, to irradiate the work-piece with the laser light at a portion that is in the second area under a second machining condition in which the work-piece is penetrated.

5. The laser machining apparatus according to claim 4, wherein a power of the laser under the first machining condition is lower than a power of the laser light under the second machining condition.

6. The laser machining apparatus according to claim 4, wherein a scanning speed of the laser light under the first machining condition is higher than a scanning speed of the laser light under the second machining condition.

7. A computer-readable, non-transitory medium storing a machining pattern generation program causing a computer to execute a process, the process comprising:
reading data regarding a target line of the work-piece which is a boundary between a first area remaining after laser machining and a second area to be removed in the laser machining;
generating first machining data for forming a groove along the target line by irradiating laser light from a laser irradiation apparatus; and
generating second machining data for irradiating the laser light at a position that is in the second area and at least partially overlaps the groove under a machining condition in which the work-piece is penetrated.
